(19) United States
(12) Patent Application Publication
(10) Pub. No.: US 2010/0315684 A1
(43) Pub. Date: Dec. 16, 2010

(54) Information processing device, detachable storage medium access control circuit, and image forming apparatus

(75) Inventor: Hiromasa Koike, Saitama-shi (JP)

Correspondence Address: Harness, Dickey & Pierce P.L.C., P.O. Box 8910, Reston, VA, 20195, US

(73) Assignee: Ricoh Company, Ltd.

(21) Appl. No.: 12/801,361

(22) Filed: Jun. 4, 2010

(30) Foreign Application Priority Data
Jun. 11, 2009 (JP) 2009-140506

(51) Int. Cl. G06F 15/00; H04N 1/38

(52) U.S. Cl. 358/1.16; 358/463

(57) ABSTRACT

An information processing device including a printed circuit board, to access a detachable storage medium, including a control device, provided on the printed circuit board, to control access to the storage medium; a slot connector, provided on the printed circuit board to accept the storage medium; a junction portion between the storage medium and the printed circuit board, to receive a signal from the storage medium; a signal line connected between the junction portion and the control device, to transmit a signal from the storage medium to the control device; a noise line connected between the junction portion and a ground terminal, to transmit noise from the junction portion to the ground terminal; and a noise absorption element, provided in the noise line between the junction portion and the ground terminal.

### CROSS-REFERENCE TO RELATED APPLICATIONS

This patent specification claims priority from Japanese Patent Application No. 2009-140506, filed on Jun. 11, 2009 in the Japan Patent Office, which is hereby incorporated by reference herein in its entirety.

### BACKGROUND OF THE INVENTION

1. Field of the Invention

The present invention relates to a detachable storage medium access control circuit, an information processing device such as personal computers, printers, and multifunction devices, to access a detachable storage medium, and an image forming apparatus incorporating the detachable storage medium access control circuit.

2. Discussion of the Background

At present, information processing devices such as PCs, printers, and multifunction devices, have functions to access card-type storage media, which facilitate receiving and sending data between the storage media and the information processing devices.

Typical storage media include SD card (registered trademark), Compact Flash (registered trademark), Memory Stick (registered trademark), and xD picture card (registered trademark). In order to use these media, the information processing devices have printed circuit boards on which slot connectors into which the storage media are inserted, control devices to access the storage media, and control circuits that enable communication between the control devices and the storage media.

While users are attaching or detaching the storage medium to and from the information processing device, noise such as static electricity may be generated in the printed circuit board in the information processing device. In particularly, when the static electricity charged in the human body is discharged to the printed circuit board via the storage medium, malfunction of the control circuit on the printed circuit board and destruction of the control device may be caused by the noise including the static electricity.

It is preferable that this noise not affect the control circuit and the control device by transferring noise to a metallic component such as the chassis, passing through a connection point between the printed circuit board and the chassis.

In order to prevent such external noise from affecting the control circuit and the control device, several approaches have been proposed.

For example, in JP-H05-36455-A, a connector of a storage medium includes signal lines each of which is bifurcated into two. More specifically, a resistor of high resistance value is provided in one of the bifurcated signal lines of the connector of the storage medium. When the storage medium is inserted, the bifurcated signal line with the resistor of high resistance value initially connects to a signal line of an electronic circuit substrate (printed circuit board) in an information processing device. At this time, communication between the printed circuit board in the information processing device and the storage medium is performed through the other bifurcated signal line in the connector of the storage medium. Therefore, noise can be prevented from entering an electronic circuit in the printed circuit board.

However, connecting terminals (in the connectors) of the storage media are standardized because the storage media are used in various information processing devices such as personal computers (PCs), printers, and multifunction devices, and therefore the storage media cannot adopt any particular connector including the above-described signal line examples.

If the above-described connecting terminal is used in the storage medium, a custom order connector in the information processing device is required, which lacks the necessary versatility.

Although a noise remover such as a diode or a capacitor is generally provided in a signal line, the noise that often is several kilo volts cannot be completely removed if the noise remover is not positioned appropriately. Additionally, when the noise (e.g., static electricity) enters the printed circuit board, the ground (GND) voltage level fluctuates, as a result of which the correct voltage reference in a power supply used in the printed circuit board cannot be maintained.

Therefore, there is market demand for the information processing device to separate the requisite signals from the noise appropriately without requiring a particular connector in the storage media.

### SUMMARY

In view of the foregoing, one illustrative embodiment of the present invention provides an information processing device including a printed circuit board, to access a detachable storage medium, that includes a control device, a slot connector, a junction portion, a signal line, a noise line, and a noise absorption element. The control device, provided on the printed circuit board, controls access to the storage medium. The slot connector is provided on the printed circuit board to accept the storage medium. The junction portion between the storage medium and the printed circuit board receives a signal from the storage medium. The signal line connected between the junction portion and the control device transmits a signal from the storage medium to the control device. The noise line connected between the junction portion and a ground terminal transmits noise from the junction portion to the ground terminal. The noise absorption element is provided in the noise line between the junction portion and the ground terminal.

Another illustrative embodiment of the present invention provides a detachable storage medium access control circuit that includes a control device, an input terminal, a signal line, a noise line, and noise absorption element. The control device controls access to the storage medium. The input terminal receives a signal from the storage medium. The signal line that is connected between the input terminal and the control device transmits a signal in the storage medium to the control device. The noise line that is connected between the input terminal to a ground terminal transmits noise in the storage medium to the ground terminal. The noise absorption element is provided in the noise line between the input terminal and the ground terminal.

Another illustrative embodiment of the present invention provides an image forming apparatus incorporating the detachable storage medium access control circuit described above.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram illustrating an information processing device 1, according to one illustrative embodiment;

FIG. 2A is a schematic diagram illustrating the media controller included in the information processing device, according to one illustrative embodiment;

FIG. 2B shows an electronic circuitry configuration of the media controller 2 shown in FIG. 2A;

FIG. 2C is a cross-sectional diagram of the media controller 2 shown in FIG. 2A;

FIG. 3A is a schematic diagram illustrating a media controller 2A according to another illustrative embodiment;

FIG. 3B shows an electronic circuit configuration of the media controller 2 shown in FIG. 3A;

FIG. 4A is a schematic diagram illustrating a media controller 2B according to another illustrative embodiment;

FIG. 4B shows an electronic circuit configuration of the media controller 2 shown in FIG. 4A;

FIG. 5A is a schematic diagram illustrating a media controller 2C according to another illustrative embodiment; and

FIG. 5B shows an electronic circuit configuration of the media controller 2 shown in FIG. 5A.

### DETAILED DESCRIPTION OF PREFERRED EMBODIMENTS

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve a similar result.

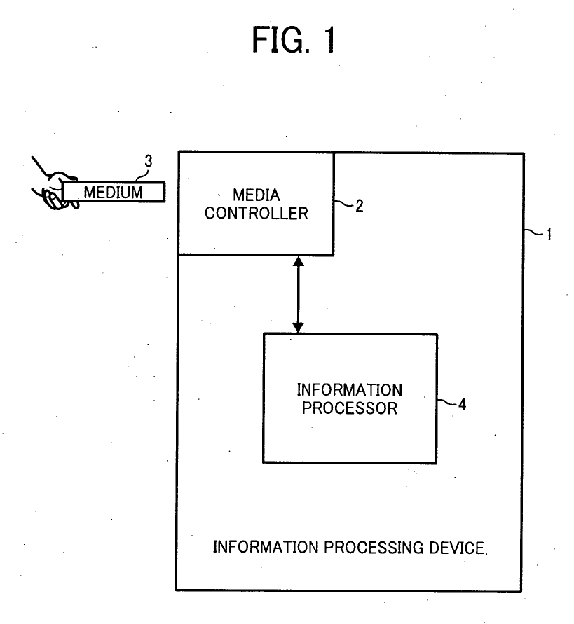

Referring now to the drawings, wherein like reference numerals designate identical or corresponding parts throughout the several views thereof, particularly to FIG. 1, an information processing device according to illustrative embodiments of the present invention is described below.

FIG. 1 is a schematic diagram illustrating an information processing device 1 such as a printer or a multifunction device, that has a function that can access a medium inserted into a slot connector provided on a printed circuit board in the information processing device 1. In FIG. 1, the information processing device 1 may be any device that conducts information processing, including but not limited to a printer or multifunction device.

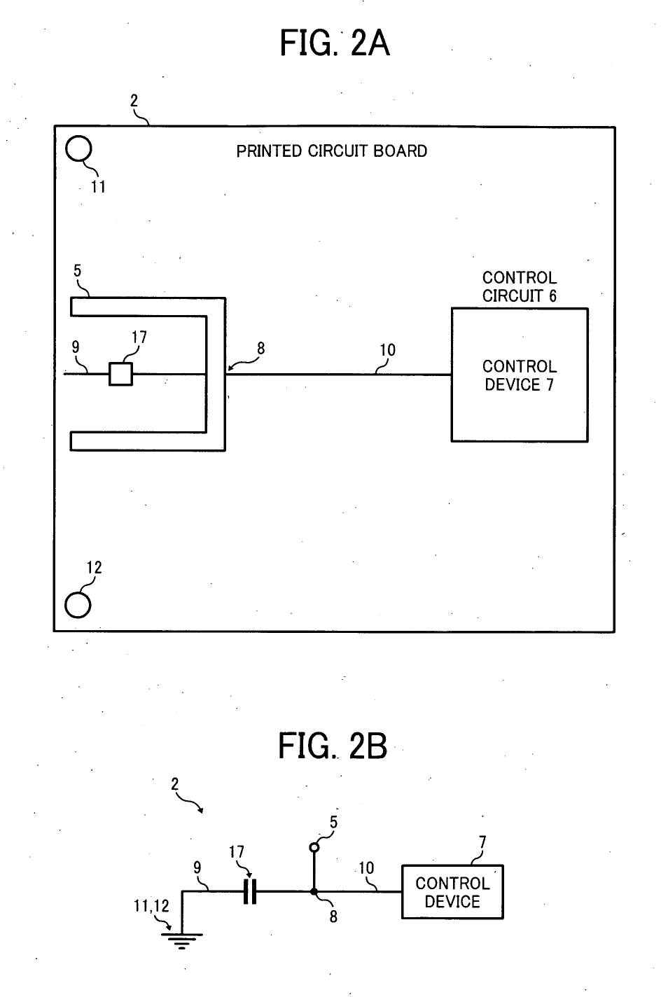

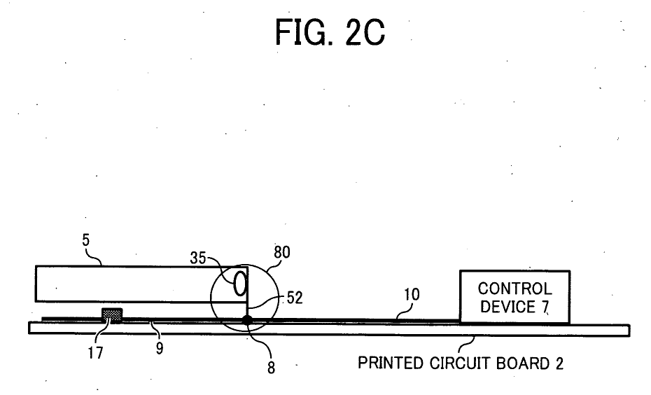

The information processing device 1 includes a media controller 2 (hereinafter also “printed circuit board 2”) and an information processing portion 4. The media controller 2 is a printed circuit board on which a slot connector 5, a control circuit 6, a control device 7, and a noise absorption element 17 are mounted, which are described in further detail later with reference to FIGS. 2A through 5B. When a storage medium 3 (hereinafter also “medium 3”) is inserted into the slot connector 5 in the media controller 2, the media controller 2 can access the medium 3 by electrically connecting the medium 3 to the control device 7 via the control circuit 6.

In this specification, “access the medium” means reading data from and writing data into the storage medium 3.

The storage medium 3 is, for example, SD card (registered trademark), Compact Flash (registered trademark), Memory Stick (registered trademark), or xD picture card (registered trademark), which stores data into a nonvolatile memory such as a flash read only memory (ROM) and is portable. The respective media are standardized, which facilitates handling of data for various machines types pursuant to their respective standards.

The information processing portion 4 can receive the data such as image data from the storage medium 3 via the media controller 2, execute image processing to print out the data, and write data onto the storage medium 3 via the media controller 2.

In embodiments to be described below, as shown in FIGS. 2A through 5B, the information processing device 1 (printer or multifunction device) has a function to access the storage medium 3 by inserting the storage medium 3, which is a detachably attachable storage media of a card type, into the slot connector 5 provided on the printed circuit board 2 (media controller).

With reference to FIG. 2C, in the information processing device 1, the medium 3 is connected to the slot connector 5 at a junction node 35 provided in the slot connector 5, and the junction node 35 is connected to a connecting terminal 52 that connects the slot connector 5 and the printed circuit board 2. Additionally, on an edge of the connecting terminal 52 on the printed circuit board 2 side, a bifurcation point 8 is connected to (bifurcated into) a signal line 9 (hereinafter “noise line 9”) extending to the printed circuit board 2 side (hereinafter ground terminal side) and a signal line 10 extending to the control circuit 6 side. A requisite signal is transmitted from the medium 3 to the control device 7 through the signal line 10, and noise including static electricity is outputted to the terminal of the printed circuit board 2 through the absorption element 17 in the noise line 9.

In general, while the user is attaching or detaching the medium 3 to and from the information processing device 1, static electricity is generated from the human body. With this circuit configuration, the noise including static electricity is transferred from the printed circuit board 2 to a metal portion (not shown), such as a chassis, which can prevent malfunction of the control circuit 6 caused by the noise of static electricity.

FIG. 2A is a schematic diagram illustrating the media controller 2 according to a first embodiment. FIG. 2B shows an electronic circuit configuration of the media controller 2 shown in FIG. 2A.

In FIGS. 2A through 5B, for ease of explanation and illustration, only a single signal line and a single noise line are shown. However, other multiple signal lines and noise lines have a configuration similar to that of the single signal line and the single noise line shown in FIGS. 2A through 5B.

In the media controller 2 that is the printed circuit board 2 on which the slot connector 5, the control circuit 6, the control device 7, and the noise absorption element 17 are mounted, when the user processes the data of the medium 3 (shown in FIG. 1) using the information processing device 1 (shown in FIG. 1), the medium 3 is held in the slot connector 5.

When a terminal (not shown) of the medium 3 is connected to a terminal (not shown) of the slot connector 5, the slot connector 5 can communicate with the control device 7 via the control circuit 6 on the printed circuit board 2.

While the user uses the medium 3, that is, while the user attaches or detaches the medium 3 to and from the information processing device 1, the static electricity that is charged in the human body is discharged to the printed circuit board 2 via the medium 3.

In the embodiment shown in FIGS. 2A through 2C, signal in the medium 3 is inputted from the junction node 35 between the medium 3 and the slot connector 5. Then, after passing through the connecting terminal 52, the signal is bifurcated into the noise line 9 on the ground terminal side and the signal line 10 on the control circuit 6 side, and the noise including a static electricity flows to the terminal of the printed circuit board 2 via the noise absorption element 17 in the noise line 9.

It is to be noted that, because the junction node 35 and the connecting terminal 52 and the bifurcation point Bare electrically closely connected, the connecting point 35, the connecting terminal 52, the bifurcation point 8 together form as a junction portion 80. The junction portion 80 between the medium 3 and the printed circuit board 2 serves as an input terminal that receives the signal from the medium 3.

Herein, this circuit including the control device 7, the input terminal (80), the signal line 10, the noise line 9, and the noise absorption element 17 serves as a detachable storage medium access control circuit.

The noise flowing through the noise line 9 flows through a pattern on the printed circuit board 2 via the noise absorption element 17 and then flows to junction nodes 11 and 12 (hereinafter “fixed screws”) between the printed circuit board 2 and the chassis (not shown). If the noise absorption element 17 is not provided, in the event that the electric energy of the noise is large the noise may affect other patterns on the printed circuit board 2 while passing through the pattern on the printed circuit board 2 to the chassis and to the fixed screws 11 and 12.

Therefore, in order to prevent the noise from affecting the other patterns by absorbing the noise, the noise absorption element 17 that in the present embodiment is a capacitor (hereinafter also “capacitor 17”) is provided in the noise line 9 downstream from the bifurcation point 8 in a direction in which the noise flows from the media 3 to the printed circuit board 2 (hereinafter “direction of noise flow”), thereby reducing the electrical energy of the noise including the static electricity. Thus, malfunction of the control circuit 6 on the printed circuit board 2 and the destruction of the control device 7 can be prevented.

In addition, because the noise absorption element (capacitor) 17 is provided in the noise line 9, electrical impedance of the signal line 9 is decreased below that of the signal line 10. When the electrical impedance differs between the noise line 9 and the signal line 10, the noise including the static electricity flows to the line whose impedance is lower. By taking advantage of this feature, the noise including the static electricity can be reliably separated from the requisite signal for communication, and the noise flows through the noise line 9.

Subsequently, the noise flowing though the noise line 9 passes through the pattern on the printed circuit board 2 and flows to the substrate chassis via the fixed screws 11 and 12. The fixed screws 11 and 12 serve as ground terminals.

As described above, because the signal wire is bifurcated into the signal line 10 and the noise line 9, the requisite signal is separated from the noise including the static electricity, and the noise including the static electricity can be prevented from flowing to the control circuit 6. In addition, the capacitor 17 provided in the noise line 9 can absorb (reduce) the noise including the static electricity in the noise line 9 downstream from the bifurcation point 8 in the direction of noise flow.

Therefore, malfunction of the control circuit 6 on the printed circuit board 2 and destruction of the control device 7 caused by the noise including the static electricity can be prevented.

With reference to electronic circuitry of the media controller 2 shown in FIG. 2B, the noise including the static electricity leaking from the slot connector 5 tries to flow to the control device 7 through the signal line 10 on the printed circuit board. However, because the electric impedances between the noise line 9 and the signal line 10 differ, the noise including the static electricity can be reliably separated from the requisite signal for the communication, and the noise flows through the noise line 9. Therefore, the noise flows to the fixed screws (ground terminals) 11 and 12 via the capacitor 17, and the noise does not flow to the control device 7.

### Second Embodiment

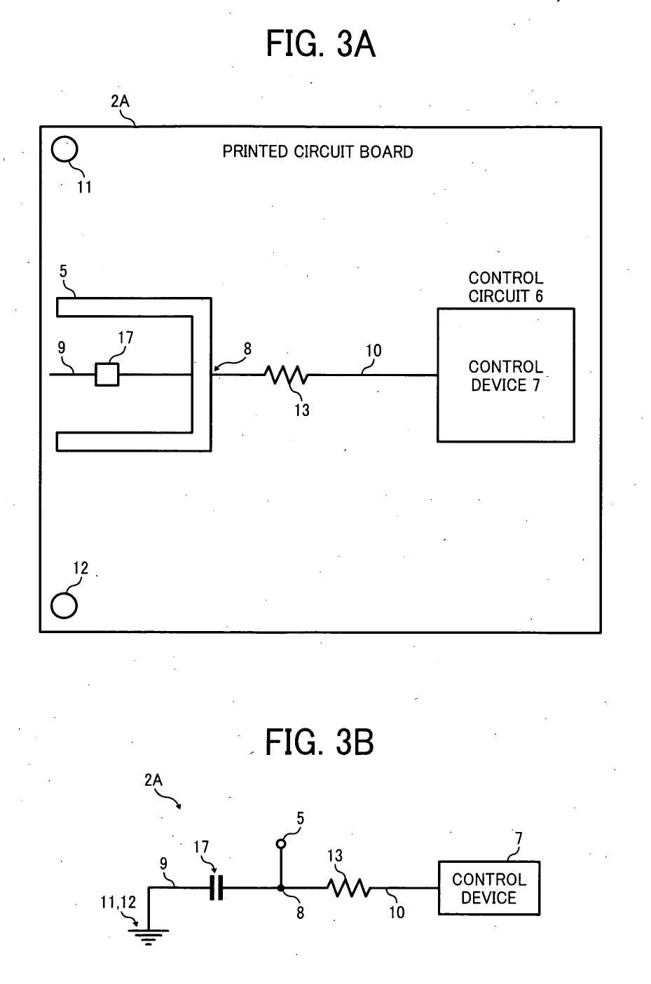

FIG. 3A is a schematic diagram illustrating a media controller 2A according to a second embodiment. FIG. 3B shows an electronic circuit configuration of the media controller shown in FIG. 3A.

It is to be noted that, for ease of explanation and illustration, because the media controller 2A has a configuration similar to the configuration of the media controller 2 in the first embodiment, other components of the media controller 2A are represented by identical numerals and the description thereof is omitted below. The user operates (attaches and detaches) the medium 3 to the media controller 2A similarly to the media controller 2.

In this embodiment, a damping resistor 13 is provided in a signal line 10A on a side of the control circuit 6 downstream from the bifurcation point 8. Accordingly, electrical impedance of the signal line 10A is increased by providing the damping resistor 13 above that of the noise line 9.

Therefore, because the difference in the electrical impedance between the noise line 9 and the signal line 10A is further increased, the noise including the static electricity can be more reliably separated from the requisite signal for the communication, and the noise flows through the noise line 9.

With reference to electrical circuitry of the media controller 2A shown in FIG. 3B, the noise including the static electricity leaking from the slot connector 5 tries to flow the control device 7 via the signal line 10A on the printed circuit board 2A. However, because of the difference in the electric impedance between the signal line 10A and the noise line 9, the requisite signal is separated from the noise including the static electricity. Therefore, the noise flows to the fixed screws (ground terminals) 11 and 12 via the noise absorption element 17, and the noise does not flow to the control device 7.

As described above, because the damping resistor 13 is located in the signal line 10 on the side of the control circuit 6 downstream from the bifurcation point 8, the difference in the electric impedance between the signal line 10A and the noise line 9 is generated. Thus, the requisite signal is separated from the noise including the static electricity, and therefore, the malfunction of the control circuit 6 on the printed circuit board 2 and the destruction of the control device 7 (control IC) can be prevented.

With reference to electronic circuitry of the media controller 2A shown in FIG. 3B, the noise including the static electricity leaking from the slot connector 5 tries to flow to the control device 7 through the signal line 10A of the printed circuit board 2. However, because the electric impedance between the signal line 10A and the noise line 9 differs greatly, the requisite signal is more reliably separated from the noise including the static electricity. Therefore, the noise flows to the ground terminals 11 and 12 via the noise absorption element 17, and the noise does not flow to the control device 7.

### Third Embodiment

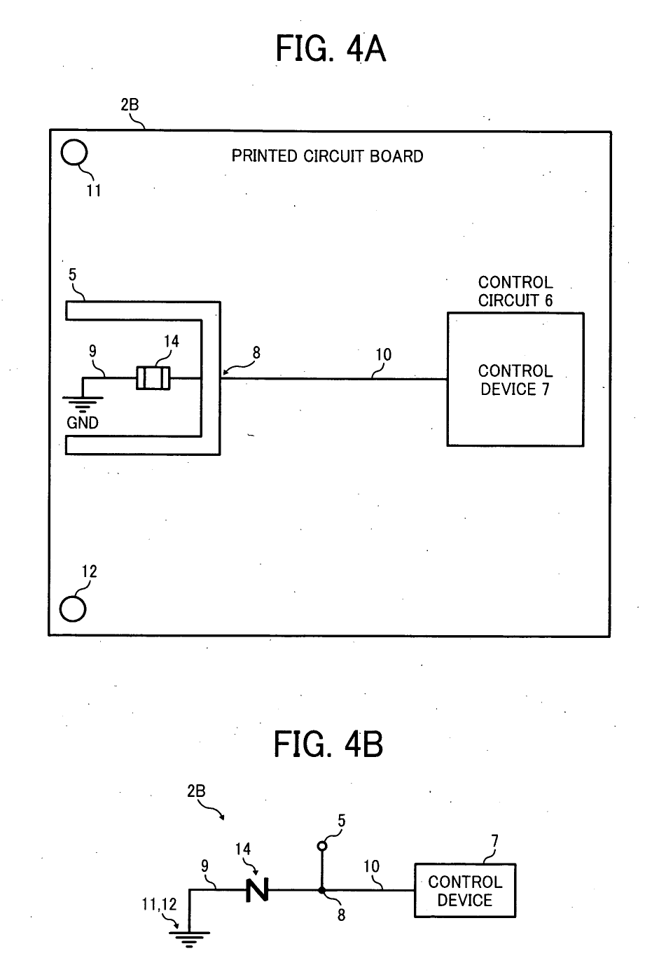

FIG. 4A is a schematic diagram illustrating a media controller 2B according to a third embodiment. FIG. 4B shows an electric circuit configuration of the media controller 2B shown in FIG. 4A.

As shown in FIG. 4A, although the media controller 2B has a configuration similar to the media controller 2 shown in FIG. 2A, the media controller 2B includes a varistor 14, serving as a noise absorption (removal) element, provided in a noise line 9B on the ground terminal side downstream from the bifurcation point 8, instead of the capacitor 17 shown in FIG. 2A.

Because the varistor 14 provided in the noise line 9B is connected between the bifurcation point 8 and the GND terminal of the printed circuit board 2, the varistor 14 can remove the noise in the noise line 9B.

More specifically, when the voltage applied between the terminals of the varistor 14 exceeds a rated voltage, the resistance value between terminals of the varistor 14 is decreased to several Ω to several tens Ω, and when the voltage therebetween is less than the rated voltage, the resistance value therebetween is over approximately 2 mega ohm (MΩ).

Similarly to the media controller 2, in the media controller 2B including the varistor 14 malfunction of the control circuit 6 on the printed circuit board 2 and destruction of the control device 7 can be prevented because the noise flows not to the control device 7 but to the (fixed screws) ground terminals 11 and 12 via the varistor 14.

It is to be noted that a diode can also serve as the noise absorption element 17. Further, the media controller 2B including the varistor 14 can also adopt the damping resistor 13 shown in FIG. 3A as the noise absorption element.

### Fourth Embodiment

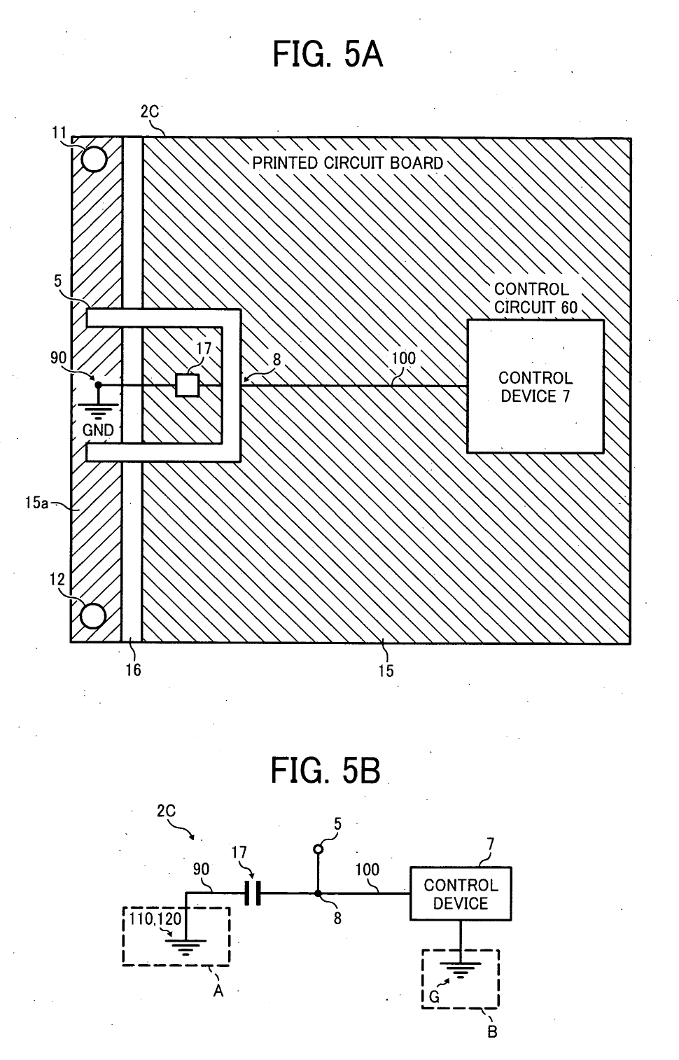

FIG. 5A is a schematic diagram illustrating a media controller (printed circuit board) 2C according to a fourth embodiment. FIG. 5B shows an electronic circuit configuration of the media controller 2C shown in FIG. 5A.

As shown in FIG. 5A, a ground (GND) area (GND pattern) 15 including a control circuit 60 is separated from a ground GND area (GND pattern) 15a connected to fixed screws 110 and 120 in the printed circuit board 2C that is the media controller 2C. Because an area 16 that has no pattern is located between the GND area 15 and 15a a creeping distance can be kept. Thus, the ground terminal to which a noise line 90 is connected, positioned in the ground GND area 15a, is electrically separated from the control device 60 on the printed circuit board 2C.

Separating the GND area 15 from the GND area 15a as described above in order prevent external noise from entering the GND area 15 including the control circuit 60 is generally known. However, if the noise including the static electricity directly enters the junction portion 80 (FIG. 2C) without bifurcating into the signal line 10 and the noise line 9, no effects can be attained by separating the GND area 15a connected to the fixed screws 110 and 120 from the GND area 15.

Therefore, in the present embodiment, a noise line 90 on the side of the ground terminal downstream from bifurcation point 8 is connected to the GND area 15a that is connected to the fixed screws 110 and 120 (ground A shown in FIG. 5B) isolated from a ground B (shown in FIG. 5B), causing the noise including the static electricity to flow to the chassis via the noise absorption element 17. Consequently, the separated noise flows to the chassis via the fixed screws 110 and 120 without any harmful effect on the other pattern (s), and thus malfunction of the control circuit 60 on the printed circuit board 2C and destruction of the control device 7 can be prevented.

As described above, because the pattern 15a to which the noise line 90 is connected is isolated from the other pattern (s) 15 in the printed circuit board 2C, the noise separated from signals transmitted to the control device 7 is prohibited from flowing to the printed circuit board 2C via the GND area 15 on the printed circuit board 2C. Therefore, malfunction of the control circuit 60 on the printed circuit board 2C caused by the noise including the static electricity and destruction of the control device 7 can be prevented.

With reference to FIG. 5B, the noise including the static electricity leaking from the slot connector 5 tries to flow to the signal line 100 that is connected to the control device 7. However, the impedance of the noise line 90 on the ground terminal side connected to the noise absorption element 17 is low, and the noise tends to flow to the ground terminals (the fixed screws) 110 and 120 via the noise absorption element 17. Herein, the ground B in the control device 7 is separated from a ground A constituted by the ground terminals 110 and 120. Therefore, fluctuation in ground level caused by the noise flowing to the ground A can be minimized.

Additionally, the configurations shown in FIG. 2A though FIG. 4B can be combined freely on the printed circuit board 2C shown in FIGS. 5A and 5B, in which the pattern to which the noise line is connected is electrically separated from other patterns of the media controller. As a result, the media controller can have further tolerance for the noise.

Numerous additional modifications and variations are possible in light of the above teachings. It is therefore to be understood that, within the scope of the appended claims, the disclosure of this patent specification may be practiced otherwise than as specifically described herein.

What is claimed is:

1. An information processing device including a printed circuit board, to access a detachable storage medium, comprising:
a control device, provided on the printed circuit board, to control access to the storage medium;
a slot connector, provided on the printed circuit board to accept the storage medium;
a junction portion between the storage medium and the printed circuit board, to receive a signal from the storage medium;
a signal line connected between the junction portion and the control device, to transmit a signal from the storage medium to the control device;
a noise line connected between the junction portion and a ground terminal, to transmit noise from the junction portion to the ground terminal; and
a noise absorption element, provided in the noise line between the junction portion and the ground terminal.

2. The information processing device according to claim 1, wherein the junction portion comprises a junction node between the storage medium and the slot connector, a connecting terminal connecting the slot connector and the printed circuit board, and a bifurcation point between the signal line and the noise line.

3. The information processing device according to claim 1, wherein the noise absorption element is a capacitor.

4. The information processing device according to claim 1, wherein the noise absorption element is a varistor.

5. The information processing device according to claim 1, further comprising:
a damping resistor, provided in the signal line.

6. The information processing device according to claim 1, wherein the ground terminal connected to the noise line is electrically separated from the control device on the printed circuit board.

7. A detachable storage medium access control circuit, comprising:
a control device to control access to the storage medium;
an input terminal to receive a signal from the storage medium;
a signal line to transmit a signal in the storage medium to the control device, connected between the input terminal and the control device;
a noise line connected between the input terminal to a ground terminal to transmit noise in the storage medium to the ground terminal; and
a noise absorption element provided in the noise line between the input terminal and the ground terminal.

8. The detachable storage medium access control circuit according to claim 7, wherein the noise absorption element is a capacitor.

9. The detachable storage medium access control circuit according to claim 7, wherein the noise absorption element is a varistor.

10. The detachable storage medium access control circuit according to claim 7, further comprising:
a damping resistor, provided in the signal line.

11. The detachable storage medium access control circuit according to claim 7, wherein the ground in the noise line is electrically separated from the control device on the printed circuit board.

12. An image forming apparatus incorporating the circuit of claim 7.

13. The image forming apparatus according to claim 12, wherein the noise absorption element is a capacitor.

14. The image forming apparatus according to claim 12, wherein the noise absorption element is a varistor.

15. The image forming apparatus according to claim 12, further comprising:
a damping, resistor, provided in the signal line.

16. The image forming apparatus according to claim 12, wherein the ground in the noise line is electrically separated from the control device on the printed circuit board.
